(19) United States
(12) Patent Application Publication
(10) Pub. No.: US 2026/0343232 A1
(43) Pub. Date: Oct. 29, 2026

(54) Integrity Event Monitoring for AI/ML based Positioning

(71) Applicant: Telefonaktiebolaget LM Ericsson (publ), Stockholm (SE)

(72) Inventors: Zhan Zhang, Beijing (CN); Yufei Blankenship, Springfield, IL (US)

(21) Appl. No.: 19/117,885

(22) PCT Filed: Sep. 27, 2023
(86) PCT No.: PCT/EP2023/076657

§ 371 Date: Apr. 2, 2025

(30) Foreign Application Priority Data
Oct. 3, 2022 (WO) PCT/CN2022/123692

(51) Int. Cl. H04W 12/104; H04L 41/16; H04W 64/00; H04W 84/12

(52) U.S. Cl. CPC H04W 12/104; H04L 41/16; H04W 64/006; H04W 84/12

(57) ABSTRACT

The embodiments herein relate to integrity event monitoring for Artificial Intelligence/Machine Learning, AI/ML, based positioning. In some embodiments, it is proposed a method (600) performed by a first network element implementing Integrity Event Monitoring Function, IEMF. In an embodiment, the method (600) may comprise the step of estimating (S601) the positioning errors (PE) of an AI/ML based positioning, according to one or more reference sources. In an embodiment, the method (600) may further comprise the step of comparing (S602) the estimated PE with one or more factors, to monitor positioning integrity of the AI/ML based positioning. The embodiments herein may provide solid basis for cellular network to detect positioning erroneous events and eventually manage the integrity of service.

### CROSS REFERENCE TO RELATED APPLICATION

This application claims priority of PCT Application Serial Number PCT/CN2022/123692 filed on Oct. 3, 2022 with title of “INTEGRITY EVENT MONITORING FOR AI/ML BASED POSITIONING”, the entire contents of which are incorporated herein by reference.

### TECHNICAL FIELD

The embodiments herein relate generally to the field of positioning, and more particularly, the embodiments herein relate to integrity event monitoring for Artificial Intelligence/Machine Learning (AI/ML) based positioning.

### BACKGROUND

Learning capability of AI creates advantageous policies or strategies directly based on data instead of human logics and symbolic modeling and analysis. AI/ML enabled solutions essentially employ data-driven learning approaches where the models learn the underlying data distribution and relationship between the inputs and outputs without the need for understanding the underlying complex processes. ML has been found to be an effective tool in radio positioning, for instance, 3gpp has now been investigating on AI/ML based positioning method, i.e., channel state information or time of arrival measurements based so-called fingerprint method for positioning, especially for indoor. More details may be referred to 3GPP TR 38.901 V16.1.0 (2019-12) Technical Report, 3rd Generation Partnership Project; Technical Specification Group Radio Access Network; “Study on channel model for frequencies from 0.5 to 100 GHz (Release 16)”.

In 3GPP Rel-17, for Global Navigation Satellite System (GNSS) based positioning methods, the GNSS integrity concepts were introduced. Integrity for Radio Access Technology (RAT)-dependent positioning methods is currently under development in 3GPP.

### SUMMARY

The embodiments herein propose methods, network elements, computer readable medium and computer program product for integrity management of AI/ML based positioning.

In some embodiments, there proposes a method performed by a first network element implementing an Integrity Event Monitoring Function (IEMF). In an embodiment, the method may comprise the step of estimating the positioning errors (PE) of an AI/ML based positioning, according to one or more reference sources. In an embodiment, the method may further comprise the step of comparing the estimated PE with one or more factors, to monitor positioning integrity of the AI/ML based positioning.

In an embodiment, the one or more factors may comprise at least one of an Alert Limit (AL) or a Protection Level (PL).

In an embodiment, the PE may be estimated according to one or more radio measurements.

In an embodiment, the PE may be estimated by:

PE=\sqrt{(x−x_{ref})²+(y−y_{ref})²+(z−z_{ref})²},
wherein (x, y, z) is one of one or more coordinates estimated by the AI/ML based positioning, and (x_{ref}, y_{ref}, z_{ref}) is one of one or more respective coordinates provided by one or more reference sources.

In an embodiment, the one or more reference sources may be provided by a User Equipment (UE).

In an embodiment, the one or more reference sources may comprise one or more alternative position information sources that do not depend on New Radio (NR) radio signal.

In an embodiment, the one or more alternative position information sources that do not depend on NR radio signal may comprise at least one of: Wireless Local Area Network (WLAN) positioning, Bluetooth positioning, and sensor based positioning.

In an embodiment, the sensor based positioning may comprise using at least one of a barometric pressure sensor and a motion sensor.

In an embodiment, the one or more reference sources may comprise one or more alternative position information sources that depend on NR radio signal.

In an embodiment, the one or more reference sources may comprise one or more Positioning Reference units (PRUs).

In an embodiment, the one or more alternative position information sources that depend on NR radio signal may comprise one or more positioning approaches that depend on measurement of Downlink (DL) or Uplink (UL) reference signal for positioning.

In an embodiment, the one or more positioning approaches that depend on measurement of DL or UL reference signal may comprise at least one of: Downlink Time Difference of Arrival (DL-TDOA), Uplink Time Difference of Arrival (UL-TDOA), multi-Round Trip Time (multi-RTT), Downlink Angle of Departure (DL-AoD), Uplink Angle-of-Arrival (UL-AoA), and Enhanced Cell-ID (E-CID).

In an embodiment, the one or more alternative position information sources that depend on NR radio signal may comprise one or more positioning approaches that use side-link positioning reference signals.

In an embodiment, the one or more positioning approaches that use side-link positioning reference signals may comprise at least one of: Time Difference of Arrival (TDOA) for sidelink, Uplink Angle-of-Arrival (UL-AoA) for sidelink, and Downlink Angle of Departure (DL-AoD) for sidelink.

In an embodiment, the one or more coordinates provided by one or more reference sources may be obtained by aggregating input from two or more reference sources.

In an embodiment, the one or more reference sources may comprise geographical information.

In an embodiment, the geographical information may comprise a digital map of a radio positioning-service area.

In an embodiment, the digital map may comprise one or more accessible areas and one or more forbidden areas inaccessible.

In an embodiment, the step of estimating a PE of an AI/ML based positioning according to one or more reference sources may further comprise the step of determining a PE, when the AI/ML based positioning provides a location estimate for a UE coincides with the one or more forbidden areas.

In an embodiment, the one or more forbidden areas may comprise at least one of: building walls, physically occupied areas by some facility, and stationary objects.

In an embodiment, the method may further comprise the step of marking grades of severity for the radio positioning-service area. In an embodiment, different scores may be provided to the PE to reflect the severity of erroneous positioning estimation.

In an embodiment, the one or more reference sources may comprise crowd sourcing from one or more UEs.

In an embodiment, the method may further comprise the step of recording of continuous position changes during a time period for at least one UE of the one or more UEs.

In an embodiment, the method may further comprise the step of recording one or more positions at specified timings for at least one UE of the one or more UEs.

In an embodiment, the step of estimating a PE of an AI/ML based positioning according to one or more reference sources may further comprise the step of determining a PE, if a speed estimated from a trajectory and timing of the record exceeds a threshold that is impossible in reality at a service area.

In an embodiment, the step of estimating a PE of an AI/ML based positioning according to one or more reference sources may further comprise the step of determining a PE, if a direction variation exceeds a threshold during a time duration that is impossible for the one or more UEs in practice.

In an embodiment, the one or more reference sources comprise detected radio network malfunction.

In an embodiment, the method may further comprise the step of suspending or stopping a current AI/ML model from servicing the position request.

In an embodiment, the method may further comprise the step of triggering the AI/ML model to be re-trained and updated.

In an embodiment, the method may further comprise the step of obtaining another AI/ML model.

In an embodiment, the method may further comprise the step of outputting the monitored positioning integrity to a second network element implementing Positioning Integrity Management Function (PIMF).

In an embodiment, the first network element implementing IEMF may be a network element located within a third network element implementing a Location Management Function (LMF) or located within a g-NB.

In an embodiment, the method may be implemented in an indoor environment.

In some embodiments, there proposes a network element, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above network elements. In an embodiment, the network element may be configured as the above first network element and/or the second network element.

In some embodiments, there proposes a computer readable medium stores computer readable code, which when run on an apparatus, causes the apparatus to perform any of the above methods.

In some embodiments, there proposes a computer program product stores computer readable code, which when run on an apparatus, causes the apparatus to perform any of the above methods.

The embodiments herein may provide solid basis for cellular network to detect positioning erroneous events and eventually manage the integrity of service.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 shows an example scenario of radio propagation;

FIG. 2 is a schematic block diagram showing example architecture of a wireless communication system for integrity management of AI/ML based positioning, in which the embodiment herein may be implemented;

FIG. 3 shows an example scenario of factory indoor site with severity marks, according to the embodiments herein;

FIG. 4 shows an example scenario of factory indoor site with crowd-sourcing data, according to the embodiments herein;

FIG. 5 shows an example scenario of factory indoor site with UE trajectory recording, according to the embodiments herein;

FIG. 6 is a schematic flow chart showing an example method in the first network element, according to the embodiments herein;

FIG. 7 is a schematic block diagram showing an example first network element, according to the embodiments herein; and

FIG. 8 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

### Indoor Factory Positioning

3gpp study item on fingerprint-based machine learning method for indoor positioning has been under progress. Radio propagation at different locations differ each other. Some non-line-of-sight (NLOS) path is a dominant one for the signals, it has been found legacy method presuming line of sight (LOS) propagation degrades severely. This gives a rise of AI/ML method called by fingerprint method, which in current investigation at 3gpp could outperform legacy method in some cases, especially at NLOS dominant cases.

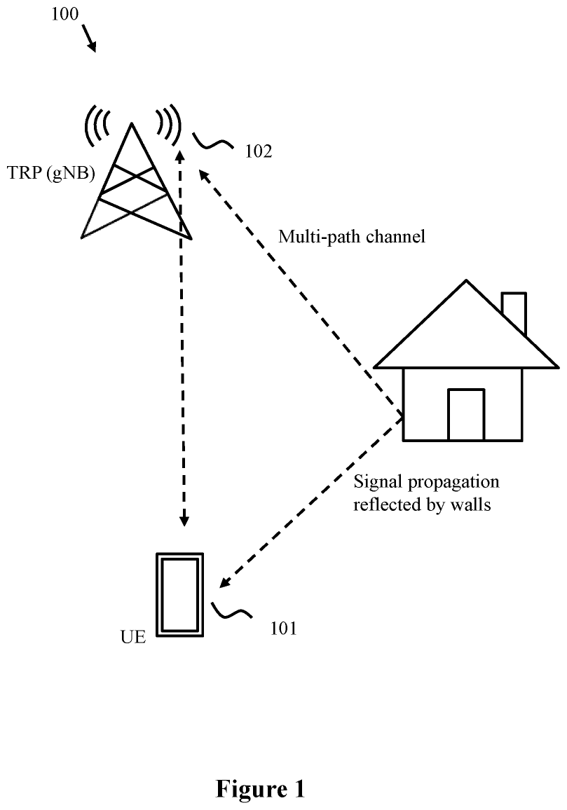

FIG. 1 shows an example scenario 100 of radio propagation. As illustrated in FIG. 1, different radio propagations between the UE 101 and the gNB 102 could result in quite different channel features, such as channel coherent bandwidth, channel variation over time and space. One of the most import features is that the channel become rich multipath at indoor, especially when the indoor is densely occupied with so-called clutters, such as machines and storages boxes. The line of sight (LOS) path between the radio base station antenna (TRP) and the User-terminal (UE) 101 is seldom available.

### Integrity Alert

Positioning integrity is measure of the trust in the accuracy of the position-related data provided by the positioning system and the ability to provide timely and valid warnings to the LCS client when the positioning system does not fulfil the condition for intended operation. Integrity focused on the tail of the positioning error distribution (i.e., the rare events), and to aims to keep the probability of hazardous events extremely low. For example, <10⁻⁷/hr Target Integrity Risk (TIR) translates to one failure permitted every 10 million hours (equivalent to 1142 years approximately).

Positioning accuracy and positioning integrity are related but separate concepts, and for many use cases, accuracy alone is insufficient to meet the requirements. Positioning devices and services are typically designed to report the distribution of errors that characterize the overall system performance, which is often specified as an error percentile representing the accuracy. For example, a road vehicle with an embedded UE positioning client may report a lane-level accuracy of <50 cm 95th percentile. In this case, the UE is indicating that, based on all the computed positions, its estimated accuracy is better than 50 cm, 95% of the time. For the remaining 5%, the position error is unknown. The 5% of errors are essentially unbounded without any way to reliably validate their distribution.

Each time a position is provided, positioning integrity can be used to quantify the trust on the provided position. Positioning integrity is therefore a method of bounding these errors and this can be done to a much higher confidence. For example, a Target Integrity Risk (TIR) of 10⁻⁷/hr translates to a 99.99999% probability that no hazardously misleading outputs occurred in a given hour of operation. The TIR sets the target for determining which feared events need to be monitored in order to meet the specified Alert Limit (AL) at this level of probability. A lower TIR introduces a wider range of threats (i.e., feared events) that need to be monitored to improve confidence in the estimated position. Erroneous position estimates which do not meet the positioning integrity criteria can then be omitted in the final positioning solution, allowing only the valid position estimates to be utilized, which also leads to higher accuracy.

Therefore, positioning integrity is an important component to ensure the reliability of a positioning system to the end user. It is an important metric in use cases such as V2X, real-time operation in assembly line, tracking of vehicles in logistics and warehousing, etc.

In general, several key concepts for Integrity support are listed below.
Target Integrity Risk (TIR): The probability that the positioning error exceeds the Alert Limit (AL) without warning the user within the required Time-to-Alert (TTA).
Alert Limit (AL): The maximum allowable positioning error such that the positioning system is available for the intended application. If the positioning error is beyond the AL, the positioning system should be declared unavailable for the intended application to prevent loss of positioning integrity.
Time-to-Alert (TTA): The maximum allowable elapsed time from when the positioning error exceeds the Alert Limit (AL) until the function providing positioning integrity annunciates a corresponding alert.
Integrity Availability: The integrity availability is the percentage of time that the PL is below the required AL.
Protection Level (PL): A statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:
Probability per unit of time [((PE>AL) & (PL<=AL)) for longer than TTA]<required TIR

Evaluation results of various AI/ML models indicate that substantial accuracy gain can be achieved by AI/ML based positioning methods at some indoor scenarios, especially where the traditional non-AI/ML methods struggle. On the other hand, thus far there is no discussion on the integrity aspect of the AI/ML based positioning methods, including the protocol to monitor AI/ML model performance to ensure the expected service integrity.

For a GNSS (i.e., a RAT-independent positioning method), the integrity monitoring can leverage the cellular network (RAT) to provide a reference UE position. But for RAT-dependent positioning methods including AI/ML based methods, it is not clear how to find an alternative, “diversity”, system which can provide a reference UE position during deployment. In addition, different service types might have different positioning requirements, including different positioning accuracy targets in order to satisfy the needs of the given applications. Therefore, there is a need to design a method to monitor the positioning integrity of the AI/ML based positioning solutions embedded in the radio networks.

In view of the above issues, the embodiments propose a solution for management of the integrity event monitoring for AI/ML based positioning of cellular network (RAT network).

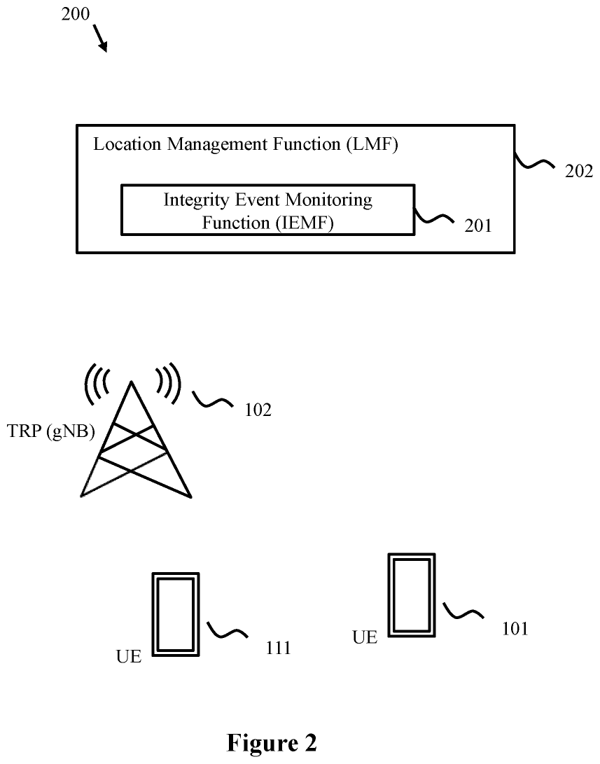

FIG. 2 is a schematic block diagram showing example architecture of a wireless communication system 200 for integrity management of AI/ML based positioning. In an embodiment, the embodiments may be implemented in the wireless communication system 200 as shown in FIG. 2.

In some embodiments, there proposes solutions of integrity event monitoring, including detect feared event by using alternative sources which does not depend on cellular network (NR) radio signal measurement, and/or exploiting geographic information, by managing positioning reference unit (PRUs), or crowd-sourcing interface. These solutions provide solid basis for cellular network to detect positioning erroneous events and eventually manage the integrity of service.

In some embodiments, there proposes methodologies to monitor positioning integrity during AI/ML model deployment, which comprise estimating the positioning errors (PE) according to one or more reference sources and compare it to AL (Alert Limit) and PL (Protection Level). The goal is to detect positioning malfunction events and keep the probability of hazardous events before the target threshold.

In this disclosure, new feared events and anomalous events are defined, and metrics and methods are proposed to assist with integrity management of the RAT AI/ML positioning service.

In an embodiment, the wireless communication system 200 may be configured in an OTT scenario. The OTT connection may be transparent in the sense that the participating communication devices through which the OTT connection passes are unaware of routing of uplink and downlink communications. For example, a base station (such as the gNB 102) may not or need not be informed about the past routing of an incoming downlink communication with data originating from the IEMF 201, the PIMF, or the LMF 202 to be forwarded (e.g., handed over) to a connected UE 101. Similarly, the base station (such as the gNB 102) need not be aware of the future routing of an outgoing uplink communication originating from the UE 101 towards the IEMF 201, the PIMF, or the LMF 202.

It should also be understood that, a network function (such as Integrity Event Monitoring Function (IEMF) 201, Positioning Integrity Management Function (PIMF, not shown) and/or Location Management Function (LMF) 202) can be implemented either as a network element on a dedicated hardware, as a software instance running on a dedicated hardware, or as a virtualized function instantiated on an appropriate platform, e.g., on a cloud infrastructure.

It should also be understood that, a network element may be any of the entity and/or function on the network, for example UE 101 or 111, base station (such as gNB 102, gNB-CU, gNB-DU), and any network function (such as IEMF 201 and/or LMF 202).

A location server is a more generic term. In 3GPP NR, the LMF 202 is a typical location server. Thus, the LMF 202 and location server are used interchangeably below.

In an embodiment, it is proposed that for the AI/ML positioning method, an integrity event monitoring function (IEMF) 201 of positioning system/function may be setup to coordinate the integrity event monitoring and communicate with relevant nodes/function (such as PIMF) for data sharing and comparison.

In an embodiment, the IEMF 201 may either be new part of location management function (LMF) 202 of existing cellular network, or a new function associated with integrity management function for AI/ML positioning in next generation cellular network (such as gNB 102).

In an embodiment, the IEMF 201 may manage a list of reference nodes, such as positioning reference units (PRUs) and may be responsible to configure their reporting of positioning-relevant events, and/or measurements.

The reported information includes one or more of the following:
PRU's location, that is “ground truth” since it can be used as ground-truth for ML model training or updating;
positioning estimates accuracies PRU obtained from network positioning service;

The PRU may receive the positioning service of the network and compare the received location estimate with its “ground truth” to output estimate accuracy measurements.
signal quality/strength of received positioning reference signal;
time-shift/synchronization errors of received positioning reference signal;
phase-jitters of received positioning reference signal.

In an embodiment, the IEMF 201 may be responsible to announce broadcasting system information for PRUs (PRU types of UEs) to join-in and register or quit and their identity check-up in the management.

In an embodiment, the PRUs may be configured to timely report one or more of the above listed information, wherein the report can be periodic (e.g., if PRU are of mobility type), or triggered (i.e., aperiodic), or semi-persistent (i.e., periodic reporting after a trigger is received).

In an embodiment, the IEMF 201 may configure the parameters that controls what types of measurements are to be reported (e.g., L1-RSRP for signal quality), what is to be measured (e.g., time/frequency configuration of the positioning reference signal), how the measurements are to be performed (the sliding window for obtaining the measurements), and how the measurements are to be reported (periodicity of the report). For example, the IEMF 201 may instruct the PRU (as a UE) about the periodicity of reporting (thus timing of reporting).

Additionally, in an embodiment, the IEMF 201 may provide assistance information to facilitate with the measurement report and/or positioning accuracy estimation.

Furthermore, in an embodiment, the IEMF 201 may be responsible for broadcasting system information for PRU to join-in, register, quit, managing the procedure and PRU's identity for check-up.

### Alternative Position Information Source

For monitoring the performance AI/ML based positioning method, an alternative source may provide Reference Location (i.e., an estimate of UE's location) together with its uncertainty.

### Alternative Position Information Sources That Do Not Depend on NR Radio Signal

In one embodiment, the alternative source may be one of the following, which does not depend on NR radio signal measurement:
WLAN positioning. The WLAN positioning method may make use of the WLAN measurements (AP identifiers and optionally other measurements) and databases to determine the location of the UE 101 or 111.
Bluetooth positioning. The Bluetooth positioning method may make use of Bluetooth measurements (beacon identifiers and optionally other measurements) to determine the location of the UE 101 or 111.
Sensor based positioning, where the sensor may be barometric pressure sensor and/or motion sensor.

The barometric pressure sensor based positioning method may make use of barometric sensors to determine the vertical component of the position of the UE 101 or 111. The UE 101 or 111 may measure barometric pressure, optionally aided by assistance data, to calculate the vertical component of its location or to send measurements to the positioning server for position calculation.

The motion sensor based positioning method may make use of different sensors such as accelerometers, gyros, magnetometers, to calculate the displacement of UE.

Moreover, if a UE is capable, multiple positioning sources (e.g., both WLAN and motion sensor) may be available to a same UE. Thus, the estimation of UE location may be obtained by aggregating input from the multiple sources.

The availability of the above sources depends on the UE capability, for example, if the UE 101 or 111 is additionally equipped with WLAN receiver, Bluetooth receiver, sensors.

### Alternative Position Information Sources That Depend on NR Radio Signal

The alternative source may be one of the following methods, or a combination thereof, which depend on NR radio signal measurement:
Positioning methods that depend on measurement of DL or UL reference signal for positioning, including: DL-TDOA, UL-TDOA, Multi-RTT, DL-AoD, UL-AoA, E-CID.
Positioning methods that uses side-link positioning reference signals. The positioning methods may be timing-based (e.g., TDOA) and/or angle-based (e.g., AoA, AoD). Side-link based position estimation is particularly useful for the indoor factory scenario, where the radio environment may be heavily cluttered and often there is no adequate LOS links between TRPs and the target UE 101 or 111. Instead of being limited to TRP-UE links, side-links between two peer UEs 101 and 111 may provide LOS links (if available) to estimate the UE location with better accuracy.

### Monitor AI/ML Model Performance

For monitoring the performance of AI/ML based positioning method, the alternative sources above may be used to provide estimation of positioning error:

PE=\sqrt{(x−x_{ref})²+(y−y_{ref})²+(z−z_{ref})²}.

In the above, (x, y, z) may be the coordinate estimated by the AI/ML based method, and (x_{ref}, y_{ref}, z_{ref}) may be the coordinate provided by the alternative source. The positioning error may be used to support the calculation of: (a) horizontal and/or vertical accuracy; (b) positioning integrity estimation.

The performance monitoring function may log the PE statistics of the AI/ML positioning method during AI/ML deployment. If the positioning accuracy in a time window is worse than the predefined accuracy target, or the TIR (Target Integrity Risk) is not satisfied, then the performance monitoring function may make a request to suspend or stop the AI/ML model from servicing the client's position request. Furthermore, performance monitoring function may trigger the AI/ML model to be re-trained and updated, or a new AI/ML model can be obtained (e.g., download from a server), so that the AI/ML method can resume operation.

### Employ Geographical Information to Detect Inaccuracy Events

In an embodiment, the IEMF 201 may optionally exploit available geographic information (GeoInfo) such as map of the radio positioning-service area, to analyze and obtain rich information about accessible areas in general, or inaccessible areas for the served UEs.

Based on such GeoInfo or other auxiliary info other than radio measurements, the IEMF 201 may identify feared events of service integrity for the RAN positioning.

Maps provide comprehensive info useful to identify inaccessible areas for the served UEs for detecting feared events.

In a positioning service area, there are many “forbidden areas” inaccessible, such as:
Building Walls;
Physically occupied areas by some facility, where a UE never is able to have those locations in reality;
Stationary objects, such as big post of lamp, big statues, UE will not be there unless stationary object is destroyed.

Whenever the positioning service provides a location estimate coinciding with these inaccessible locations for a human user or vehicle, it indicates that a serious positioning error event happens, the IEMF 201 may be responsible to detect such events of erroneous estimates and take the occurring into statistics and then output to positioning integrity management function (PIMF).

In an embodiment, the IEMF 201 may take charge of maintaining database to host the GeoInfo.

In an embodiment, the IEMF 201 may optionally analyze the map to grasp the useful GeoInfo, such accessibility or inaccessibility of certain areas within the service area for different UEs.

In an embodiment, the IEMF 201 may be responsible to update GeoInfo according to new updating of map or other visual sources such as cameras.

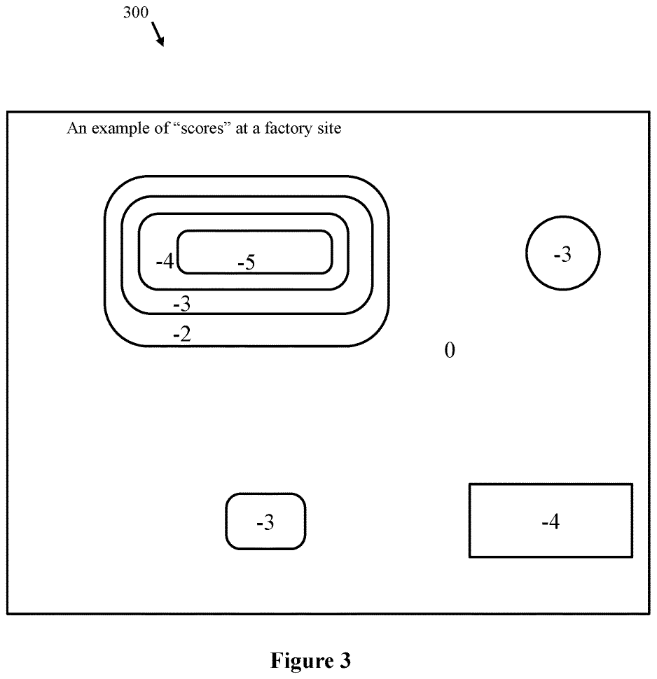

In an embodiment, the IEMF 201 may mark grades of severity of the feared events, as illustrated in the FIG. 3, different scores shown in the FIG. 3 may be provided to the event to reflect the severity of erroneous positioning estimates.

FIG. 3 shows an example scenario 300 of factory indoor site with severity marks, according to the embodiments herein; which may show severity marks (example) of the feared events.

### Managing a Set of Serviced UEs (with a Non-Radio-Measurement-Based Positioning Capability) to Report of Positioning Relevant Measurement (Crowd Sourcing Management)

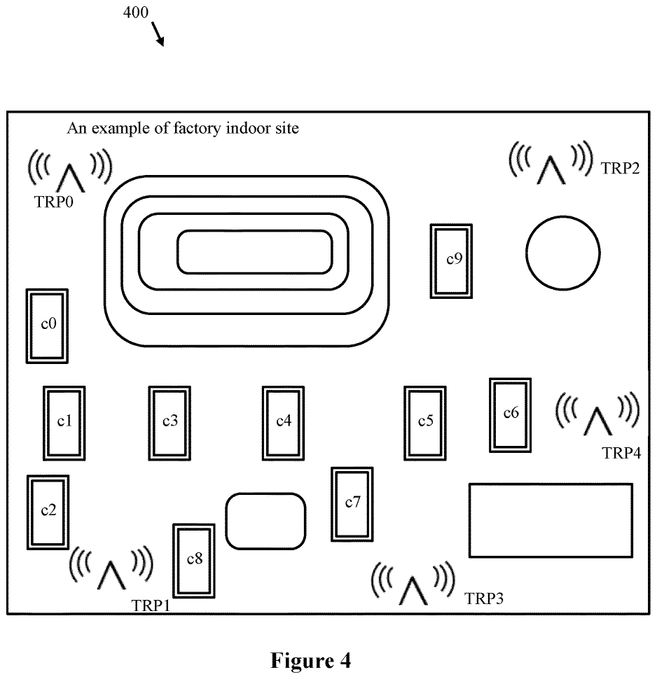

In an embodiment, the IEMF 201 may be responsible for collecting the crowd-sourcing data via managing a user interface to receive “ground truth” provided by voluntary UEs (c0-c9) with crowd-sourcing capabilities, as illustrated by FIG. 4.

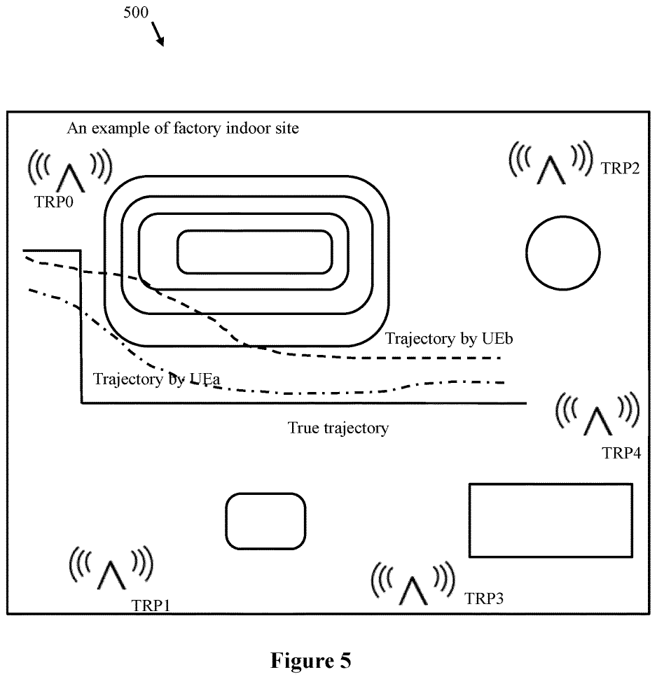

FIG. 4 shows an example scenario 400 of factory indoor site with crowd-sourcing data, according to the embodiments herein; in which the IEMF 201 may collect crowd-sourcing data and managing interface to UEs (such as c0-c9) (the TRP shown in FIG. 5 is gNB 102 or transmit-receive points).

One type of crowd-sourcing data collection may be recording of continuous position changes during a time period or list positions at specified timings of a certain UE (such as UEa and/or UEb), as illustrated by FIG. 5.

FIG. 5 shows an example scenario 500 of factory indoor site with UE trajectory recording, according to the embodiments herein; which shows UE trajectory recording to assist detection of feared events (the TRP shown in FIG. 5 is gNB 102 or transmit-receive points).

After collecting reports of the UEs (such as UEa and/or UEb), the IEMF 201 may analyze the speeds or variations in directions of the UE (such as UEa and/or UEb) according to its trajectory. The IEFM 201 may record anomalous events, for example, if the speed estimated from the trajectory and timing of the record exceeds certain threshold that is impossible in reality at a service area, or its direction variation exceeds a certain degree during a limited time duration that is impossible for the UEs (such as UEa and/or UEb) in practice.

These are typical anomalous events that may correlate with events that violate the integrity criteria of cellular RAN positioning.

### Detect Events of Radio Network Malfunction

In an embodiment, the IEMF 201 may be responsible to detect feared/anomalous event from the RAN relevant measurements, for instances, asynchronization of TRPs in time or TRP/UE power control malfunction, serious inference level intra-RAN-cell or inter-cell.

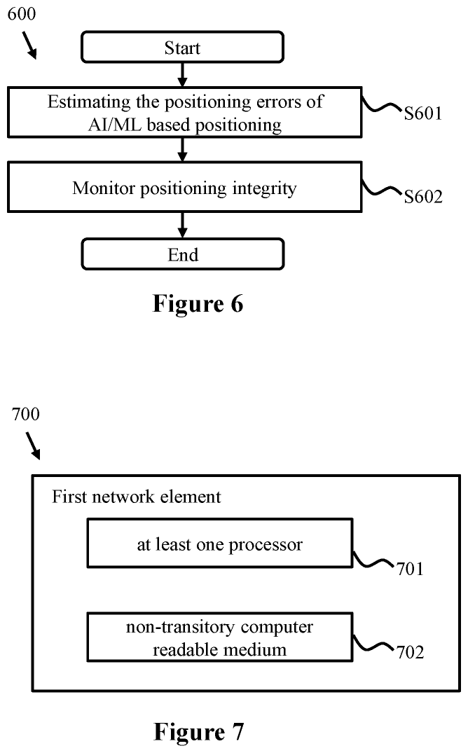

FIG. 6 is a schematic flow chart showing an example method 600 in the first network element, according to the embodiments herein. In an embodiment, the flow chart in FIG. 4 may be implemented in the IEMF 201.

The method 600 may begin with step S601, in which the first network element may estimate the positioning errors (PE) of an AI/ML based positioning, according to one or more reference sources.

Then, the method 600 may proceed to step S602, in which the first network element may compare the estimated PE with one or more factors, to monitor positioning integrity of the AI/ML based positioning.

In an embodiment, the one or more factors may comprise at least one of an Alert Limit (AL) or a Protection Level (PL).

In an embodiment, the PE may be estimated according to one or more radio measurements.

In an embodiment, the PE may be estimated by:

PE=\sqrt{(x−x_{ref})²+(y−y_{ref})²+(z−z_{ref})²}.
wherein (x, y, z) is one of one or more coordinates estimated by the AI/ML based positioning, and (x_{ref}, y_{ref}, z_{ref}) is one of one or more respective coordinates provided by one or more reference sources.

In an embodiment, the one or more reference sources may be provided by a User Equipment (UE).

In an embodiment, the one or more reference sources may comprise one or more alternative position information sources that are independent on New Radio (NR) radio signal.

In an embodiment, the one or more alternative position information sources that are independent on NR radio signal may comprise at least one of: Wireless Local Area Network (WLAN) positioning, Bluetooth positioning, and sensor based positioning.

In an embodiment, the sensor may comprise at least one of barometric pressure sensor and motion sensor.

In an embodiment, the one or more reference sources may comprise one or more alternative position information sources that are dependent on NR radio signal.

In an embodiment, the one or more reference sources may comprise one or more Positioning Reference units (PRUs).

In an embodiment, the one or more alternative position information sources that are dependent on NR radio signal may comprise one or more positioning approaches that are dependent on measurement of Downlink (DL) or Uplink (UL) reference signal for positioning.

In an embodiment, the one or more positioning approaches that depend on measurement of DL or UL reference signal may comprise at least one of: Downlink Time Difference of Arrival (DL-TDOA), Uplink Time Difference of Arrival (UL-TDOA), multi-Round Trip Time (multi-RTT), Downlink Angle of Departure (DL-AoD), Uplink Angle-of-Arrival (UL-AoA), and Enhanced Cell-ID (E-CID).

In an embodiment, the one or more alternative position information sources that are dependent on NR radio signal may comprise one or more positioning approaches that use side-link positioning reference signals.

In an embodiment, the one or more positioning approaches that use side-link positioning reference signals may comprise at least one of: Time Difference of Arrival (TDOA) for sidelink, Uplink Angle-of-Arrival (UL-AoA) for sidelink, and Downlink Angle of Departure (DL-AoD) for sidelink.

In an embodiment, the one or more coordinates provided by one or more reference sources may be obtained by aggregating input from two or more reference sources.

In an embodiment, the PE may be estimated according to geographical information.

In an embodiment, the geographical information may comprise a digital map of a radio positioning-service area.

In an embodiment, the digital map may comprise one or more accessible areas and one or more forbidden areas inaccessible.

In an embodiment, the step of S601, i.e., estimating a PE of an AI/ML based positioning according to one or more reference sources may further comprise the step of determining a PE, when the AI/ML based positioning provides a location estimate for a UE coincides with the one or more forbidden areas.

In an embodiment, the one or more forbidden areas may comprise at least one of: building walls, physically occupied areas by some facility, and stationary objects.

In an embodiment, the method may further comprise the step of marking grades of severity for the radio positioning-service area. In an embodiment, different scores may be provided to the PE to reflect the severity of erroneous positioning estimation.

In an embodiment, the PE may be estimated according to crowd sourcing from one or more UEs.

In an embodiment, the method may further comprise the step of recording of continuous position changes during a time period for at least one UE of the one or more UEs.

In an embodiment, the method may further comprise the step of recording one or more positions at specified timings for at least one UE of the one or more UEs.

In an embodiment, the step of S601, i.e., estimating a PE of an AI/ML based positioning according to one or more reference sources may further comprise the step of determining a PE, if a speed estimated from a trajectory and timing of the record exceeds a threshold that is impossible in reality at a service area.

In an embodiment, the step of S601, i.e., estimating a PE of an AI/ML based positioning according to one or more reference sources may further comprise the step of determining a PE, if a direction variation exceeds a threshold during a time duration that is impossible for the one or more UEs in practice.

In an embodiment, the PE may be estimated according to detected radio network malfunction.

In an embodiment, the method may further comprise the step of suspending or stopping a current AI/ML model from servicing the position request.

In an embodiment, the method may further comprise the step of triggering the AI/ML model to be re-trained and updated.

In an embodiment, the method may further comprise the step of obtaining another AI/ML model.

In an embodiment, the method may further comprise the step of outputting the monitored positioning integrity to a second network element implementing Positioning Integrity Management Function (PIMF).

In an embodiment, the first network element implementing IEMF may be a network element located within a third network element implementing a Location Management Function (LMF) or located within a g-NB.

In an embodiment, the method may be implemented in an indoor environment.

The above steps are only examples, and the first network function may perform any related actions described with respect to FIGS. 1 to 5.

FIG. 7 is a schematic block diagram showing an example first network element 700, according to the embodiments herein. In an embodiment, the example first network element 700 in FIG. 7 may be implemented as the IEMF 201 in FIG. 2.

In an embodiment, the first network element 700 may comprise at least one processor 701; and a non-transitory computer readable medium 702 coupled to the at least one processor 701. The non-transitory computer readable medium 702 may store instructions executable by the at least one processor 701, whereby the at least one processor 701 is configured to perform the steps in the example methods 600 as shown in the schematic flow charts of FIG. 6; the details thereof are omitted here.

Note that, the first network element 700 may be implemented as hardware, software, firmware and any combination thereof. For example, the first network element 700 may comprise a plurality of units, circuities, modules or the like, each of which may be used to perform one or more steps of the example method 600 or one or more steps described in FIGS. 1 to 5 related to the IEMF 201.

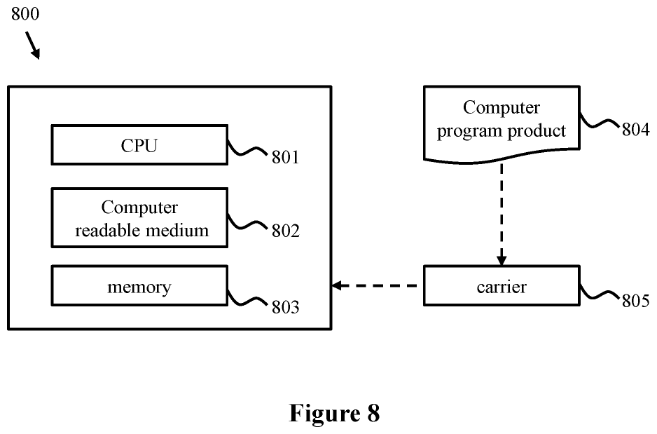

FIG. 8 is a schematic block diagram showing an example computer-implemented apparatus 800, according to the embodiments herein. In an embodiment, the apparatus 800 may be configured as the above mentioned apparatus, such as the UE 101 or 111, the gNB 102, or the IEMF 201.

In an embodiment, the apparatus 800 may comprise but not limited to at least one processor such as Central Processing Unit (CPU) 801, a computer-readable medium 802, and a memory 803. The memory 803 may comprise a volatile (e.g., Random Access Memory, RAM) and/or non-volatile memory (e.g., a hard disk or flash memory). In an embodiment, the computer-readable medium 802 may be configured to store a computer program and/or instructions, which, when executed by the processor 801, causes the processor 801 to carry out any of the above mentioned methods.

In an embodiment, the computer-readable medium 802 (such as non-transitory computer readable medium) may be stored in the memory 803. In another embodiment, the computer program may be stored in a remote location for example computer program product 804 (also may be embodied as computer-readable medium), and accessible by the processor 801 via for example carrier 805.

The computer-readable medium 802 and/or the computer program product 804 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### Abbreviations

AI Artificial Intelligence
BS Base Station
CE Channel Estimate
MAC Medium Access Control
ML Machine Learning
PBCH Physical Broadcast Channel
PSS Primary Synchronization Signal
RRC Radio Resource Control
RF Radio Frequency
SSS Secondary Synchronization Signal
TRX Transceiver
UE User Equipment.

1-34. (canceled)

35. A method performed by a first network element implementing an Integrity Event Monitoring Function (IEMF), the method comprising:
estimating a positioning error (PE) of an Artificial Intelligence/Machine Learning (AI/ML) based positioning, according to one or more reference sources; and
comparing the estimated PE with one or more factors, to monitor positioning integrity of the AI/ML based positioning.

36. The method of claim 35, wherein the one or more factors comprise at least one of an Alert Limit (AL) or a Protection Level (PL).

37. The method of claim 35, wherein the PE is estimated according to one or more radio measurements, further wherein the PE is estimated by:
PE=\sqrt{(x−x_{ref})²+(y−y_{ref})²+(z−z_{ref})²},
wherein (x, y, z) is one of one or more coordinates estimated by the AI/ML based positioning, and (x_{ref}, y_{ref}, z_{ref}) is one of one or more respective coordinates provided by the one or more reference sources.

38. The method of claim 35, wherein the one or more reference sources are provided by a User Equipment (UE).

39. The method of claim 35, wherein the one or more reference sources comprise one or more alternative position information sources that do not depend on New Radio (NR) radio signal, further wherein the one or more alternative position information sources comprise at least one of:
Wireless Local Area Network (WLAN) positioning,
Bluetooth positioning, and
sensor based positioning.

40. The method of claim 35, wherein the one or more reference sources comprise one or more alternative position information sources that depend on New Radio (NR) radio signal; or
wherein the one or more reference sources comprise one or more Positioning Reference units (PRUs).

41. The method of claim 40, wherein the one or more alternative position information sources that depend on NR radio signal comprises one or more positioning approaches that depend on measurement of Downlink (DL) or Uplink (UL) reference signal for positioning.

42. The method of claim 41, wherein the one or more positioning approaches that depend on measurement of DL or UL reference signal comprise at least one of:
Downlink Time Difference of Arrival (DL-TDOA),
Uplink Time Difference of Arrival (UL-TDOA),
multi-Round Trip Time (multi-RTT),
Downlink Angle of Departure (DL-AoD),
Uplink Angle-of-Arrival (UL-AoA), and
Enhanced Cell-ID (E-CID).

43. The method of claim 40, wherein the one or more alternative position information sources that depend on NR radio signal comprise one or more positioning approaches that use side-link positioning reference signals.

44. The method of claim 40, wherein the one or more positioning approaches that use side-link positioning reference signals comprise at least one of:
Time Difference of Arrival (TDOA) for sidelink,
Uplink Angle-of-Arrival (UL-AoA) for sidelink, and
Downlink Angle of Departure (DL-AoD) for sidelink.

45. The method of claim 37, wherein the one or more coordinates provided by one or more reference sources are obtained by aggregating input from two or more reference sources.

46. The method of claim 35, wherein the one or more reference sources comprise geographical information, further wherein the geographical information comprises a digital map of a radio positioning-service area, further wherein the digital map comprises one or more accessible areas and one or more forbidden areas inaccessible.

47. The method of claim 46, wherein estimating a PE of an AI/ML based positioning according to one or more reference sources further comprising:
determining a PE when the AI/ML based positioning provides a location estimated for a UE coincides with the one or more forbidden areas, further wherein the one or more forbidden areas comprises at least one of:
building walls,
physically occupied areas by some facility, and
stationary objects.

48. The method of claim 47, further comprising:
marking grades of severity for the radio positioning-service area;
wherein different scores are provided to the PE to reflect the severity of erroneous positioning estimation.

49. The method of claim 35, wherein the one or more reference sources comprises crowd sourcing from one or more UEs.

50. The method of claim 49, further comprising at least one of:
recording of continuous position changes during a time period for at least one UE of the one or more UEs; and
recording one or more positions at specified timings for at least one UE of the one or more UEs.

51. The method of claim 50, wherein estimating a PE of an AI/ML based positioning according to one or more reference sources further comprising at least one of:
determining a PE in response to a speed estimated from a trajectory and timing of the record exceeding a threshold that is impossible in reality at a service area; and
determining a PE in response to a direction variation exceeding a threshold during a time duration that is impossible for the one or more UEs in practice.

52. The method of claim 35, wherein the method comprises at least one of the following, based on the estimated PE:
detecting radio network malfunction;
triggering the AI/ML model to be re-trained and updated; and
obtaining another AI/ML model

53. The method of claim 35, further comprising:
outputting the monitored positioning integrity to a second network element implementing Positioning Integrity Management Function (PIMF).

54. The method of claim 35, wherein the first network element implementing IEMF is a network element located within a third network element implementing a Location Management Function (LMF) or located within a g-NB.
